(19) United States
(12) Patent Application Publication
(10) Pub. No.: US 2026/0284943 A1
(43) Pub. Date: Sep. 24, 2026

(54) METHOD FOR PRODUCING A PLASTICS MOLDED PART

(71) Applicant: Ford Global Technologies, LLC, Dearborn, MI (US)

(72) Inventors: Aydemir Kaplangiray, Alsdorf (DE); Daniel Jean Bronner, Leverkusen (DE); Kai-Uwe Lichi, Koeln (DE)

(73) Assignee: Ford Global Technologies, LLC, Dearborn, MI (US)

(21) Appl. No.: 19/572,098

(22) Filed: Mar. 19, 2026

(30) Foreign Application Priority Data
Mar. 19, 2025 (DE) 10 2025 110 529.4

(51) Int. Cl. B29C 45/14; B29C 45/26; B29C 45/72; B29L 31/30

(52) U.S. Cl. CPC B29C 45/1418; B29C 45/2673; B29C 45/7207; B29L 2031/3005

(57) ABSTRACT

A method for producing a plastics molded part includes providing a molding tool having a first tool part and a second tool part. The second tool part has a structure surface with a grain structure that corresponds to a negative shape of a grain of the plastics molded part. The method includes placing a foil between the tool parts, closing the molding tool by bringing the tool parts together, forming a tool interior space, and injecting a plastics material into an injection space formed between the foil and the first tool part. The foil is pressed against the structure surface and the grain structure is molded as a grain onto the foil. The method includes curing the plastics material. The film adheres to the plastics material while the grain is maintained. The method includes opening the molding tool and removing the plastics molded part from the molding tool.

### CROSS-REFERENCE TO RELATED APPLICATION

This application claims priority to and the benefit of German Patent Application No. 102025110529.4, filed on Mar. 19, 2025. The disclosure of the above application is incorporated herein by reference.

### FIELD

The present disclosure relates to a method for producing a plastics molded part.

### BACKGROUND

The statements in this section merely provide background information related to the present disclosure and may not constitute prior art.

In motor vehicles, the paneling of the interior compartment typically consists at least in part of plastics molded parts. These may be produced for example by injection molding. It is sometimes the case that, in different examples or variants of a vehicle model, paneling parts are installed which differ only in terms of the color and/or structure of the visible surface, not in terms of their general shape. For example, a single-colored surface having an irregular grain structure could be provided for one variant, whereas a surface which imitates a wood surface in terms of color pattern and surface structure is provided for another variant. It is scarcely possible to produce a convincing color pattern using a conventional injection molding process. It is therefore known to use a printed pattern-bearing foil, which is then back-molded with plastics material. In the case of methods such as in-mold labeling (IML) or in-mold decoration (IMD), the foil forms a carrier, from which the pattern is transferred to the plastics material. The foil is not part of the finished molded part. This method cannot be used to produce a desired surface structure. Methods are also known in which the molded part is firstly produced without a specific surface design, and a pattern-bearing foil is subsequently applied by lamination. In the so-called three-dimensional overlay method (TOM), a foil is heated and is applied to the surface of the molded part by means of an air pressure difference. This method also makes it possible to produce a specific surface structure, but is cumbersome because it has two production steps using different tools.

DE 19740468 C1 provides a method for back-molding sheet-like material, in particular foil or fabric, with plastics material. Here, use is made of an injection molding machine having a first tool part and a second tool part, which contain a tool cavity which defines the contour of the plastics molded part to be manufactured, and a third tool part, which bears the material to be back-molded and which positions the material in the tool before the back-molding with plastics melt is performed. Furthermore, use is made of a changeover element which is arranged outside the tool and which bears at least two third tool parts which are moved selectively into the tool by the changeover element before the tool is closed, wherein a heating element is provided outside the tool and preheats the material, which is arranged on the third tool part, outside the tool.

U.S. Pat. No. 5,800,771 A provides a method for forming a pattern on an article during the injection molding thereof. A pattern-bearing film is moved to a mold position in which a positive mold and a negative mold are situated opposite one another. The pattern-bearing film is heated by a heating plate, wherein a closed heating space is formed between the pattern-bearing film and a heating surface of the heating plate. The film is subsequently transferred onto an inner surface of the negative mold. The heating plate is withdrawn from the mold position, and the positive mold and negative mold are brought together. A molten resin is introduced into a cavity defined by the positive mold and the negative mold.

US 2010/0086744 A1 provides a foil based on softened polyvinyl acetals, the foil being produced in an injection molding or compression molding process. The foil may have differently colored regions. It may also contain inserts consisting of metal foils, wires, polymer fibers or the like.

U.S. 6,660,196 B1 provides a method for producing an injection-molded product. Here, a molten resin is fed to a gate channel which is formed upstream of a cavity resin feed of a cavity of a mold and which extends along a cavity resin feed, wherein the molten resin comprises a first material and a second material of different colors in a substantially separately mixed state. The molten resin is introduced from the gate channel into the cavity resin feed through a multiplicity of openings, such that the molten resin is fed in the form of a multiplicity of separate flows of the molten resin into the cavity of the mold. An injection-molded product having a straight grain pattern is formed in the cavity.

WO 2003/008172 A1 provides a method for injection-molding plastics workpieces, the method being suitable in particular for upper, lower or exchangeable housings for mobile telephones. During the injection molding process, a surface decoration is simultaneously applied to the plastics workpieces in accordance with the in-mold decoration method or the in-mold foiling method. To lower the injection pressure in the injection molding tool, at least one physical propellant is added to the plastics material.

The efficient production of plastics molded parts having individual surface designs is desirable.

### SUMMARY

This section provides a general summary of the disclosure and is not a comprehensive disclosure of its full scope or all of its features.

The present disclosure provides an efficient production of plastics molded parts having individual surface designs. Note that the features and measures individually specified in the following description may be combined with one another in any technically meaningful way and reveal further refinements of the disclosure. The description additionally characterizes and specifies the disclosure, in particular in conjunction with the figures. The expressions “first”, “second” etc. used in this application serve merely for the purposes of distinction. In particular, the use thereof is not intended to imply a sequence or priority of the objects mentioned in conjunction with these expressions.

The disclosure provides a method for producing a plastics molded part. The plastics molded part consists or comprises at least in part of plastics material. In particular, the plastics material may be a thermoplastic or thermosetting plastics material. In this context, the term “plastics molded part” is not to be interpreted as meaning that the part in question must consist entirely of plastics material. In particular, a matrix composed of plastics material may have other components, such as fibers or particles, which may not consist of plastics material, embedded therein. These could be glass fibers, carbon fibers, metal particles, mineral particles or the like. Additionally or alternatively, a surface of the molded part may have a material which cannot be classed as plastics material. The plastics molded part to be produced may in particular be a paneling part for a vehicle interior compartment, that is to say for an interior compartment of a vehicle. The vehicle may be a motor vehicle such as a passenger motor vehicle, a truck or a bus, though use for rail vehicles, aircraft or watercraft would also be conceivable in principle. In the assembled state, the paneling part may be arranged in the interior compartment of the vehicle and have a surface which is accessible from the interior compartment. This may be referred to as a class A surface.

The method comprises at least the following phases. These may be carried out in particular in the stated sequence. Where technically possible and sensible, it would however also be conceivable for the phases to be carried out at least partially simultaneously, or for the sequence in which the phases are carried out to be reversed.

In one phase, a molding tool is provided, the molding tool having a first tool part and having a second tool part which has a structure surface with a grain structure which corresponds to a negative shape of a grain of the plastics molded part. The molding tool may have further elements in addition to the stated tool parts. Each molded part may consist of or comprise metal, in particular of steel. The two tool parts are designed to jointly enclose a tool interior space. The tool interior space may also be referred to as a cavity or mold cavity. The first tool part may have a first tool interior wall, and the second tool part may have a second tool interior wall, wherein the two tool interior walls jointly delimit the tool interior space. The molding tool may also have at least one actuator for moving the tool parts, and means for preparing and supplying plastics material, for example an extruder and/or a heating device. The second tool part has a structure surface with a grain structure. The grain structure corresponds to a negative shape of a grain of the plastics molded part to be produced. The grain may also be referred to as a surface texture or texture. The overall shape of the plastics molded part is independent of the grain. The grain is superposed, as it were, on the overall shape. Accordingly, the shape of the structure surface is altogether independent of the grain structure. As will be discussed in more detail below, the grain structure has grain peaks and grain troughs, which have only slight height differences in relation to the overall extent of the structure surface. Such structures are under some circumstances individually visible only from close proximity, and under some circumstances are not individually visible at all. They are however in any case collectively tangible. They may also collectively influence the appearance of the structure surface. Whilst the coarse shape of the structure surface may be produced for example by primary forming or by cutting machining processes such as milling, other methods such as spark erosion, etching or laser machining are better suited to the production of the grain structure. The first tool part may have at least one feed channel through which plastics material can be introduced into the tool interior space.

In a further phase, a foil is introduced between the tool parts. The foil may in particular be a plastics foil which, in one example, has a thermoplastic plastics material. As thermoplastic plastics materials, use may for example be made of polycarbonates (PC), polyvinyl chloride (PVC), acrylonitrile butadiene styrene copolymers (ABS), polyethylene terephthalate (PET), or the like. It is however also possible for the foil to have other materials that are not plastics materials. These could for example be embedded particles or fibers, for example consisting of or comprising metal or other inorganic materials. The use of a metal foil would also be conceivable. The thickness of the foil can be varied in a relatively wide range, and may in particular be between 1 μm and 2 mm, in one example between 5 μm and 1 mm, and in another example between 10 μm and 500 μm. The foil may have a coating, for example an adhesion promoter or adhesive, on a side facing toward the first tool part. The foil may be secured on the second tool part. This may be achieved by mechanical clamping of the foil, or by virtue of a negative pressure being generated at the second tool part, which negative pressure causes the foil to be held on by suction.

Furthermore, the molding tool is closed by bringing the tool parts together, with a tool interior space being formed. The molding tool may be closed by actuator means. The first tool part may be a static tool part, whereas the second tool part may be a movable tool part. The tool interior space already mentioned above defines the shape of the plastics molded part to be produced. The tool parts together form the tool interior space. It is self-evident that the structure surface adjoins the tool interior space. The two tool parts are, in one example, brought together without a gap. The tool interior space is however not completely closed. It may be connected to at least one suction opening via which air can be suctioned out in order for the foil to be held on by suction. The tool interior space may also be connected to at least one ventilation opening through which air can be displaced out of the tool interior space during the injection operation. Finally, at least one opening is provided through which material can be injected into the tool interior space.

In a subsequent phase, a plastics material is injected into an injection space formed between the foil and the first tool part, whereby the foil is pressed against the structure surface and the grain structure is molded as a grain onto the foil. The injection space is part of the tool interior space. The injection space is formed between the first tool part and the foil, that is to say on a side of the foil which faces away from the structure surface. A part of the tool interior space which is situated between the foil and the second tool part can be referred to as a rear space. The rear space may, already at the start of the injection process, have a much smaller volume than the injection space. This is the case in particular if, as described, the foil is held on the second tool part by suction. The plastics material may be injected through the at least one abovementioned feed channel within the first tool part. During the injection process, the plastics material is in a liquid or at least plasticized state. It can thus adapt to different shapes. The injection space available to the plastics material is delimited by the first tool part and by the foil. When the plastics material expands into the injection space, it pushes the foil toward the second tool part. In the process, the volume of the injection space increases, and the volume of the rear space decreases. To inhibit trapped air from impeding the injection operation, the injection space may communicate with at least one abovementioned air outlet opening, through which trapped air can escape. The foil comes into contact with the structure surface at the latest as a result of the action of the plastics material, and is pressed against the structure surface by the pressure of the plastics material. This has the result that the grain structure is molded onto the foil and, there, forms a grain of the foil as a negative. It is self-evident that the plastics material and the interposed foil also adapt to the overall shape of the structure surface, whereby the coarse three-dimensional shape of the plastics molded part is produced.

A further phase comprises curing the plastics material to form the plastics molded part, wherein the film adheres to the plastics material whilst the grain is maintained. The curing may, in places, occur already during the injection process, but it occurs at least in part after the injection process. In this context, “curing” refers to the hardening of the plastics material, that is to say the change from a liquid or plasticized state into a solid state. During the curing process, the foil remains enclosed between the plastics material and the structure surface, with the result that the grain is maintained and no spring-back into the original state of the foil is possible. The foil furthermore adheres to the plastics material. Depending on the composition of the plastics material and of the foil and on the conditions prevailing during the injection and curing processes, the adhesion may be based on different effects. For example, it would be possible for the foil to be fused or sintered onto the plastics material. It would also be possible for mechanical interlocking to occur between the foil and the cured plastics material. The adhesion may also be promoted by an abovementioned adhesion promoter or adhesive on that side of the foil which faces toward the injection space. Other mechanisms in addition to these are also conceivable. As a result of the adhesion of the foil and the curing of the plastics material, the plastics molded part is formed. This therefore not only consists of the plastics material but also has, on the side facing toward the second tool part, a surface that is formed by the foil. The surface is characterized by the described grain, which constitutes the negative shape of the grain structure.

Finally, the molding tool is opened, and the plastics molded part is removed from the molding tool. That is to say, the two tool parts are moved apart, and the plastics molded part is removed. It may be the case that, after being removed, the plastics molded part is not yet ready for use but finish machining may occur. This could for example occur in a deburring operation, or cutting off protruding parts from the foil.

The method according to the disclosure makes it possible, in a single process and using a single tool, to produce a plastics molded part that has a high-quality structured surface. Here, the surface is formed by the foil, which has a desired grain as a result of the molding of the grain structure. The coloration of the surface can also be defined by the foil independently of the plastics material. It would however also be possible for the foil to be transparent, whereby the color of the plastics material is also visible from the outside. A further advantage lies in the fact that the foil can have better chemical and/or mechanical resistance than the plastics material.

In particular, the shape of the structure surface may correspond to an extent surface on which the grain structure is superposed, wherein grain peaks and grain troughs of the grain structure are offset with respect to one another perpendicularly to the extent surface. The extent surface corresponds to the coarse macroscopic shape of the structure surface. The grain structure is superposed on the extent surface, that is to say the grain structure corresponds to slight local deviations from the extent surface. The grain structure has a plurality of grain peaks and grain troughs, wherein the grain peaks constitute the protruding parts, and the grain troughs constitute the recessed parts, of the grain structure. In particular, the grain peaks and grain troughs may be offset with respect to one another by a maximum grain depth that is, in one example, between 1 μm and 1 mm, in another example between 2 μm and 500 μm, and in yet another example between 4 μm and 200 μm. Here, the maximum grain depth corresponds to the greatest offset between adjacent grain peaks and grain troughs perpendicularly to the extent surface.

In one example of the method, a foil is used which, when it is introduced between the tool parts, already has a three-dimensional shape adapted to the structure surface. That is to say, the foil has already been shaped in a preceding shaping process, for example by deep drawing or the like, such that its shape at least approximately corresponds to the structure surface. In particular, the shape of the foil may correspond to the abovementioned extent surface of the structure surface. In this case, the foil may also be referred to as a parison. When the foil is placed between the tool parts, it can adapt to the structure surface with only a small spacing. That is to say, the abovementioned rear space is already small at the start of the injection process. In this example, the foil may in particular be clamped into the second tool part. This is possible for example if the shape of the foil has somewhat larger dimensions, at least in certain regions, than the space defined by the structure surface. Although this method variant has prior deformation of the foil, an advantage consists in the fact that only relatively little deformation of the foil may occur during the injection molding process. This makes it possible, for example, to more easily achieve precise molding of the grain structure.

In another example of the method, a foil is used which has a shape, in particular a flat shape, which is independent of the structure surface. In this case, the foil can be used in a state in which it has been unwound from a roll, for example. In any case, the shape of the foil is unrelated to the structure surface, and is adapted to the shape thereof during the injection molding process. It can also be stated that the shape of the foil is independent of the extent surface. By contrast to the abovementioned example, a generally significant deformation of the foil therefore may occur during the injection molding process, which could potentially impede exact molding of the grain structure. On the other hand, prior deformation of the foil is dispensed with, that is to say the shaping of the foil takes place entirely within the method according to the disclosure together with the injection molding process.

In one example, to provide the molding tool, the second tool part is assembled by virtue of an exchangeable insert which has at least a part of the structure surface being connected to a base element, wherein the insert is selected from a plurality of inserts which are connectable to the base element. That is to say, the second tool part has at least one base element to which an insert can be connected. The structure surface is formed entirely or partially on the insert. The insert can be connected to the base element for example using screws or other detachable connecting means. To assemble the second tool part, an insert is selected from a plurality of inserts and connected to the base element. The inserts, in one example, have differently shaped structure surfaces. It is thus possible, by exchanging the insert, to produce differently shaped plastics molded parts using one molding tool.

The insert is, in one example, selected from a plurality of inserts, the structure surfaces of which differ only by having different grain structures. That is to say, on each of the inserts, the structure surface may be characterized by an identical extent surface, whilst the grain structures are different. The shape of the plastics molded part that is produced is thus largely identical in the case of all inserts. It however differs in terms of the grain. By selecting different inserts, it is thus possible to targetedly vary the grain in order to produce different variants of a component as desired. It is thus possible to produce paneling parts having different grains, which may correspond to different trim configurations of a vehicle model. The different grains may correspond to more or less high-quality appearance and haptic properties of the paneling part. For example, one grain could correspond to a slightly roughened plastics surface, whilst another grain could correspond to a wood texture. There are self-evidently also a large number of other design possibilities in this context, which are not mentioned here.

The plastics material may have a thermoplastic plastics material, which is injected at a temperature above a melting temperature into the injection space and cures as a result of cooling to below the melting temperature. In particular, the plastics material may be formed by the thermoplastic plastics material, though it may also comprise other constituents such as particles or fibers that do not consist of plastics material. The term “thermoplastic plastics material” can also be used for simplicity. Alternatively, the plastics material may also comprise a thermosetting plastics material, which is cured by heating to above a curing temperature. The plastics material may be formed by the thermosetting plastics material, though it may again also comprise constituents that do not consist of plastics material. In this case, the term “thermosetting plastics material” can also be used.

In a variant of the method, the foil is plasticized as a result of the action of the plastics material, and the grain structure is plastically molded. This is possible in particular if the foil consists or comprises at least in part of a thermoplastic plastics material. This can be plasticized by an elevated temperature of the plastics material. In addition or alternatively, plasticization may also be affected by pressure or shear forces that act on the foil as it is pressed against the structure surface. A plastic, that is to say permanent deformation of the foil is possible by way of the plasticization. This promotes the molding of the grain structure and thus the production of the grain. The adhesion of the foil to the plastics material can also be promoted, because the foil also plastically adapts to the shape of the plastics material. Furthermore, the foil and plastics material may be fused or sintered onto one another. The plasticization by the action of temperature is possible both in the case of a plastics material having a thermoplastic plastics material, before this cures as a result of cooling, and in the case of a plastics material having a thermosetting plastics material, when this is heated for curing purposes.

A plastic deformation of the foil may be advantageous, but may not occur in every case for successful implementation of the method. In an alternative example, the foil is elastically deformed between the plastics material and the structure surface, wherein the grain structure is elastically molded, and wherein the foil adheres to the plastics material, whereby the grain is maintained after the plastics material has cured. That is to say, the deformation of the foil and thus the molding of the grain are of an elastic nature, and would thus be only temporary when considered in isolation. The foil however adheres to the plastics material. When the plastics material cures, not only is its own shape preserved, but so too is that of the adherent foil. The grain is thus maintained after release from the structure surface. It is possible here that the deformation of the foil exhibits not only elastic components but also plastic components.

Aside from the individual surface structure, it is also possible for other aspects of the surface of the plastics molded part to be configured as desired. This applies in particular to the color and pattern of the surface. In one example of the method, the foil is selected from a plurality of foils of different coloration. The different coloration may encompass both different colors, for example in the case of single-colored foils, and different patterns. That is to say, the foil may already have a pattern when it is introduced between the tool parts, the pattern being maintained as a surface pattern after the molded part has been fully manufactured. In some examples, a pattern of the foil and a surface structure may be coordinated with one another. For example, the pattern could replicate the color of a wood surface, whilst the surface structure replicates the haptic properties of the wood surface.

The present disclosure provides a plastics molded part that has been produced in particular by means of a method of the type described above. The advantages described above with regard to the method are correspondingly associated with the plastics molded part according to the disclosure. In particular, the plastics molded part can be produced in accordance with any one of the abovementioned refinements or in accordance with a combination of at least two of the refinements with one another.

A molding tool is also provided that is configured in particular for carrying out the method in a refinement of the type described above, or combinations thereof, in order to produce a plastics molded part. The advantages described above with regard to the method are correspondingly associated with the molding tool according to the disclosure. In particular, the molding tool can be used in accordance with any one of the abovementioned refinements or in accordance with a combination of at least two of the refinements with one another.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

Further advantageous details and effects of the disclosure will be discussed in more detail below on the basis of an exemplary form illustrated in the figures, in which:

FIG. 1 is a cross-sectional side view of a molding tool and of a foil in a first phase of a method according to one example of the present disclosure;

FIG. 1A is an enlarged detail view from FIG. 1;

FIG. 2 is a cross-sectional view corresponding to FIG. 1 in a second phase of the method according to one example of the present disclosure;

FIG. 3 is a cross-sectional view corresponding to FIG. 1 in a third phase of the method according to one example of the present disclosure;

FIG. 3A is an enlarged detail view from FIG. 3;

FIG. 4 is a cross-sectional view corresponding to FIG. 1 in a fourth phase of the method according to one example of the present disclosure;

FIG. 5 is a cross-sectional view corresponding to FIG. 1 in a fifth phase of the method according to one example of the present disclosure;

FIG. 5A is an enlarged detail view from FIG. 5;

FIG. 6 is a cross-sectional view corresponding to FIG. 1 in a sixth phase of the method according to one example of the present disclosure;

FIG. 6A is an enlarged detail view from FIG. 6;

FIG. 7 is a cross-sectional side view of a molding tool and of a foil in a first phase of an alternative example of a method according to the present disclosure;

FIG. 8 is a cross-sectional view corresponding to FIG. 7 in a second phase of the method according to one example of the present disclosure;

FIG. 9 is a cross-sectional side view of a base element of a tool part of the molding tool and of three inserts according to one example of the present disclosure; and

FIGS. 10A-10C are enlarged detail views from FIG. 9.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the various figures, identical parts are always denoted by the same reference signs, for which reason the parts will generally also be described only once.

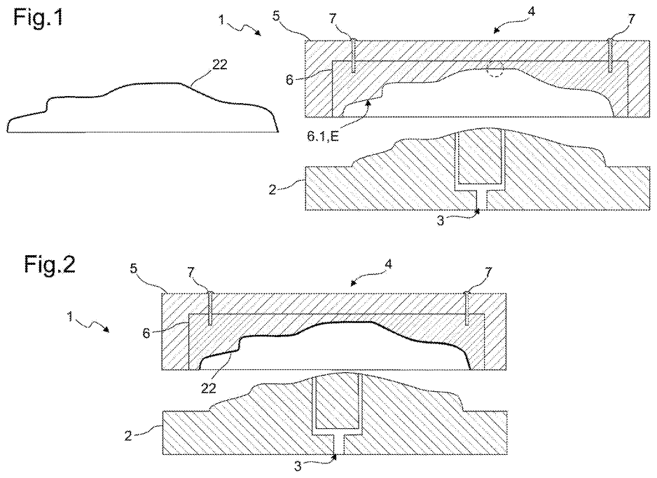

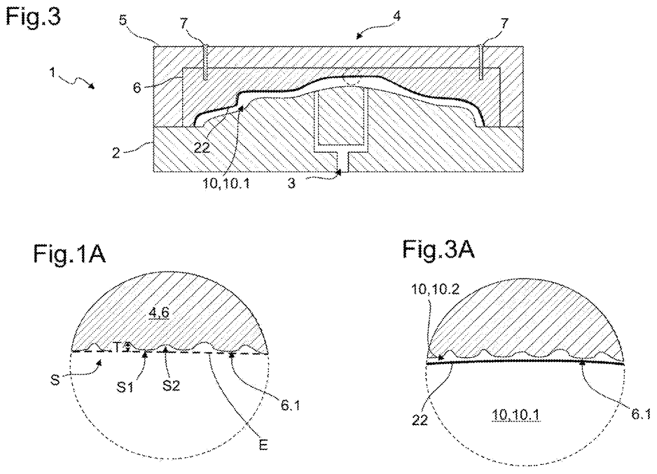

FIG. 1 shows a sectional side view of a molding tool 1 and of a foil 22 during a first phase of a method according to the disclosure, whilst FIG. 1A shows an enlarged detail of the region bounded by the circular dashed line in FIG. 1.

The molding tool 1 has a first tool part 2 having a feed channel 3, and has a second tool part 4 which is movable relative to the first tool part 2. The second tool part 4 has a base element 5 and has an insert 6 that is detachably connected to the base element 5 by means of a plurality of screws 7. The molding tool 1 is illustrated in schematic and simplified form. Other detachable connecting means may also be used instead of the screws 7. The insert 6 has a structure surface 6.1 having a grain structure S that can be seen in the enlarged detail illustration in FIG. 1A. The grain structure S has a multiplicity of grain peaks S1 and grain troughs S2. The grain structure is superposed on an extent surface E of the structure surface 6.1, which corresponds to the general course of the structure surface 6.1 that can be seen in FIG. 1. The extent surface E can be defined for example as a surface tangential to the grain peaks S1 or as a surface tangential to the grain troughs S2. Both the grain peaks S1 and the grain troughs S2 may for example be punctiform, linear or areal in relation to the extent surface E. Perpendicularly to the extent surface E, the grain troughs S2 are offset with respect to the grain peaks S1 by a grain depth T, which may for example be between 1 μm and 1 mm, in particular between 2 μm and 500 μm, or between 4 μm and 200 μm. Altogether, the grain structure S corresponds to the negative shape of a grain N of a plastics molded part 20 to be produced.

FIG. 1 shows the molding tool 1 in an opened state, with the tool parts 2, 4 spaced apart from one another. Also illustrated is a foil 22, which in this example is formed as a parison. That is to say, the three-dimensional shape of the foil 22 has already been adapted to the shape of the structure surface 6.1 in a preceding deformation process. It can also be stated that the shape of the foil at least approximately corresponds to the extent surface E. The foil may be of somewhat larger dimensions such that it can be clamped into the second tool part 4. Alternatively or in addition, the foil 22 may also be held on the structure surface 6.1 by suction. For this purpose, the second tool part 4 may have suction channels (not illustrated here) that are connected to a negative pressure source. The foil 22 may in particular consist or comprise entirely or partially of plastics material, in particular of a thermoplastic plastics material. The thickness of the foil 22 can be varied in a relatively wide range. It may be between 1 μm and 2 mm, in one example, between 5 μm and 1 mm, and in another example between 10 μm and 500 μm.

After the foil 22 has been placed into the second tool part 4 as illustrated in FIG. 2, the tool parts 2, 4 are moved together, and the molding tool 1 is thus closed. This state is illustrated in FIG. 3, wherein FIG. 3A represents an enlarged detail from FIG. 3. The two tool parts 2, 4 together define a tool interior space 10, which can also be referred to as mold cavity or cavity. The tool interior space is divided by the foil 22 into an injection space 10.1 and a rear space 10.2. The injection space 10.1, which is formed between the foil 22 and the first tool part 2, corresponds to the predominant part of the volume of the tool interior space 10, whereas, in this example, the rear space 10.2 is of significantly smaller volume and is formed predominantly between the foil 22 and the grain troughs S2.

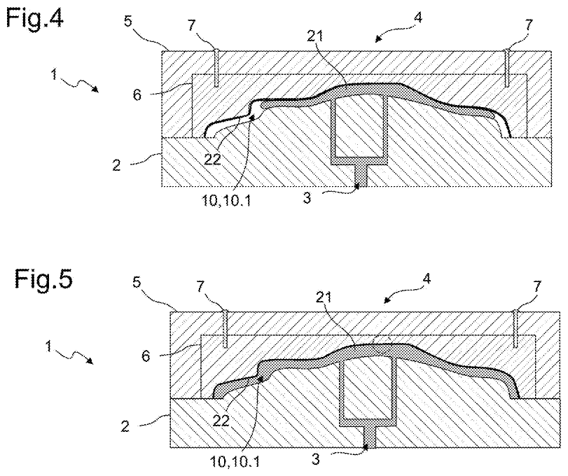

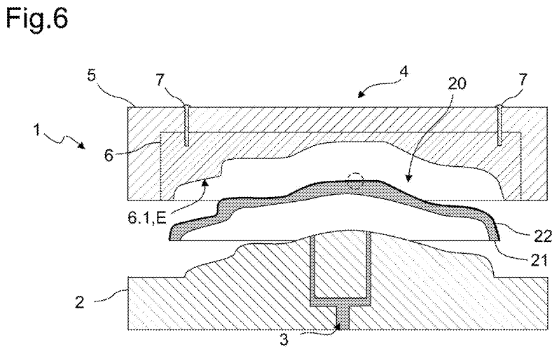

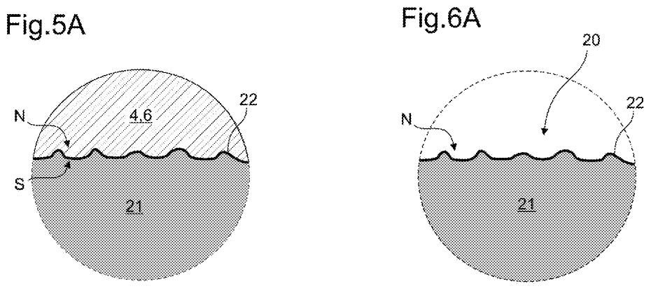

A plastics material 21 is injected into the injection space 10.1 via the feed channel 3. The plastics material 21 may for example consist or comprise entirely or predominantly of a thermoplastic plastics material which, before being injected, has been plasticized and heated to above its melting temperature. As illustrated in FIG. 4, the point of injection onto the foil 22 is situated approximately centrally within the tool interior space 10, and the plastics material 21 subsequently also moves to the sides of the foil 22. The pressure exerted by the plastics material 21 causes the foil 22 to be pressed against the structure surface 6.1. If the foil 22 has thermoplastic properties, the foil 22 can be plasticized by the heat of the plastics material 21, which promotes an adaptation to the structure surface 6.1. The foil 22 finally lies over its full extent against the structure surface 6.1, such that the rear space 10.2 practically disappears. At this time, the entire injection space 10.1 has been filled with plastics material 21, as illustrated in FIG. 5 and FIG. 5A. The adaptation of the foil 22 to the grain structure S causes a grain N to be molded onto the foil 22. As already mentioned, the molding may be based on plastic deformation of the foil 22. In the case of a thermosetting plastics material 21, this may also be achieved by virtue of the plastics material 21 being heated to above a curing temperature, which also results in the foil 22 being heated and thus plasticized.

When the plastics material 21 has been cured either by cooling (in the case of a thermoplastic plastics material) or by heating (in the case of a thermosetting plastics material), the foil 22 remains adhered to the plastics material 21 and, together therewith, forms the plastics molded part 20 that is illustrated in FIG. 6. The molding tool 1 can then be opened by moving the tool parts 2, 4 apart, and the finished plastics molded part 20 can be removed. As can be seen in the detail illustration in FIG. 6A, the grain N is maintained in the process. As described, this may be based on the plastic deformation of the foil 22. However, the grain N may also be maintained by virtue of the foil 22 adhering to the cured plastics material 21, even if the foil 22 has been only elastically deformed. In some examples, the foil 22 may, on the side facing towards the injection space 10.1, have an adhesion promoter or an adhesive that promotes adhesion to the plastics material 21.

The grain N created on the foil 22 determines the haptic properties of the plastics molded part 20 and, to some extent, also the appearance thereof. Additionally, if desired, different foils 22 of a desired coloration may be used, whereby it is possible to create a desired appearance of the plastics molded part 20 independently of the color of the plastics material 21. It is possible here to use both single-colored or transparent foils 22 and multi-colored, in particular patterned foils. A pattern of the foil 22 may optionally be coordinated with the grain N. For example, it would be possible for the pattern and the grain N to be coordinated with one another in order to imitate a wood surface.

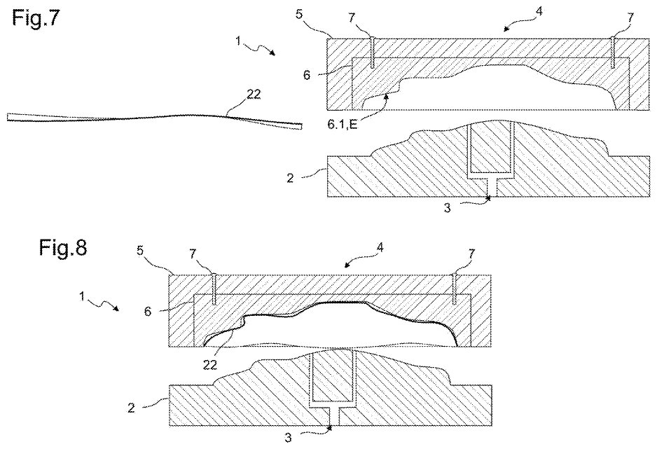

FIGS. 7 and 8 show an alternative example of the method according to the disclosure, in which use is made of a foil 22 having a shape which is independent of the shape of the structure surface 6.1. In this example, the foil 22 is approximately flat. Owing to its flexibility, however, it can be placed into the second tool part 4 as illustrated in FIG. 8, although it cannot adapt as closely to the shape of the structure surface 6.1 as the parison illustrated in FIG. 1. Subsequently, as in the first example, the molding tool 1 is closed and the plastics material 21 is injected, with the foil 22 again being pressed against the structure surface 6.1, and the grain N being molded. The further phases of the method are not illustrated here, because they correspond to the first example of the method as described above.

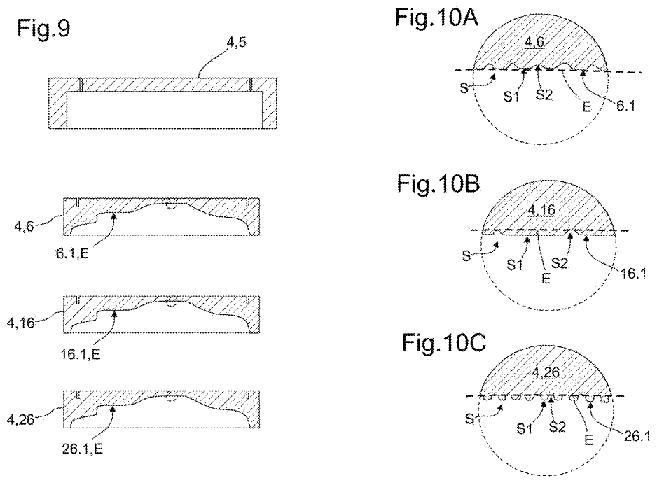

As already mentioned, the insert 6 is connected to the base element 5 of the second tool part 4 by means of screws 7 or other detachable fastening means. It is therefore possible to selectively combine different inserts 6, 16, 26 with one and the same base element 5, as indicated in FIG. 9. The three illustrated inserts 6, 16, 26 have different structure surfaces 6.1, 16.10.1, 26.1, which however each have an identical extent surface E. Accordingly, the geometrical dimensions of the manufactured plastics molded part 20 are identical in the case of all three inserts 6, 16, 26. However, the inserts 6, 16, 26 differ in terms of the grain structure S, as shown in the enlarged detail illustrations in FIG. 10A to 10C. The first insert 6 has a grain structure in which the grain troughs S2 are separated by grain peaks S1 of moderate extent. In the second insert 16, the grain troughs S2 are separated from one another by grain peaks S1 of greater extent. In the third insert 26, the grain peaks S1 have a very small extent. By selecting a suitable insert 6, 16, 26, it is possible to produce a plastics molded part 20 having identical dimensions but having a different grain N. Through suitable selection of the foil 22, it is in turn possible to influence the coloration of the plastics part 20 in virtually any desired manner.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing a plastics molded part, the method comprising:
providing a molding tool having a first tool part and a second tool part, the second tool part defining a structure surface with a grain structure which corresponds to a negative shape of a grain of the plastics molded part;
placing a foil between the first tool part and the second tool part;
closing the molding tool by bringing the first tool part and the second tool part together, thereby forming a tool interior space;
injecting a plastics material into an injection space formed between the foil and the first tool part, whereby the foil is pressed against the structure surface and the grain structure is molded as the grain onto the foil;
curing the plastics material to form the plastics molded part, wherein a film adheres to the plastics material while the grain is maintained; and
opening the molding tool and removing the plastics molded part from the molding tool.

2. The method according to claim 1, wherein a shape of the structure surface corresponds to an extent surface on which the grain structure is superposed, and grain peaks and grain troughs of the grain structure are offset with respect to one another perpendicularly to the extent surface by a maximum grain depth is between 1 μm and 1 mm.

3. The method according to claim 2, wherein the maximum grain depth is between 2 μm and 500 μm.

4. The method according to claim 2, wherein the maximum grain depth is between 4 μm and 200 μm.

5. The method according to claim 1, wherein the placing the foil between the first tool part and the second tool part further comprises providing the foil with a three-dimensional shape that corresponds to the structure surface.

6. The method according to claim 1, wherein the foil has a shape that is independent of the structure surface.

7. The method of claim 6, wherein the shape of the foil is flat.

8. The method according to claim 1, wherein the second tool part includes an insert which has at least a part of the structure surface being connected to a base element, and the method further comprises selecting the insert from a plurality of inserts which are connectable to the base element.

9. The method according to claim 8, wherein a surface of each of the inserts of the plurality of inserts differs only by having different grain structures.

10. The method according to claim 1, wherein the plastics material includes a thermoplastic plastics material and the method further comprises injecting the thermoplastic plastics material at a temperature above a melting temperature into the injection space and curing the thermoplastic plastics material by cooling to below the melting temperature.

11. The method according to claim 1, wherein the plastics material includes a thermosetting plastics material, and the method further comprises curing the thermosetting plastics material by heating to above a curing temperature.

12. The method according to claim 1, further comprising plasticizing the foil by the plastics material, and the grain structure is plastically molded.

13. The method according to claim 1, further comprising elastically deforming the foil between the plastics material and the structure surface, wherein the grain structure is elastically molded, and the foil adheres to the plastics material such that the grain is maintained after the plastics material has cured.

14. The method according to claim 1, wherein the foil is selected from a plurality of foils of different coloration.

15. A method for producing a plastics molded part, the method comprising:
providing a molding tool having a first tool part and a second tool part, the second tool part defining a structure surface with a grain structure which corresponds to a negative shape of a grain of the plastics molded part;
placing a foil between the first tool part and the second tool part, the foil having a three-dimensional shape that corresponds to the structure surface;
closing the molding tool by bringing the first tool part and the second tool part together, thereby forming a tool interior space;
injecting a plastics material into an injection space formed between the foil and the first tool part, the foil is pressed against the structure surface and the grain structure is molded as the grain onto the foil;
curing the plastics material to form the plastics molded part, and a film adheres to the plastics material while the grain is maintained; and
opening the molding tool and removing the plastics molded part from the molding tool,
wherein the shape of the structure surface corresponds to an extent surface on which the grain structure is superposed, and grain peaks and grain troughs of the grain structure are offset with respect to one another perpendicularly to the extent surface.

16. The method according to claim 15, wherein the second tool part includes an insert which has at least a part of the structure surface being connected to a base element, and the method further comprises selecting the insert from a plurality of inserts which are connectable to the base element.

17. The method according to claim 16, wherein a surface of each of the inserts of the plurality of inserts differs only by having different grain structures.

18. The method according to claim 15, further comprising plasticizing the foil by the plastics material, and the grain structure is plastically molded.

19. The method according to claim 15, further comprising elastically deforming the foil between the plastics material and the structure surface, wherein the grain structure is elastically molded, and the foil adheres to the plastics material such that the grain is maintained after the plastics material has cured.

20. A method for producing a plastics molded part, the method comprising:
providing a molding tool having a first tool part and a second tool part, the second tool part defining a structure surface with a grain structure which corresponds to a negative shape of a grain of the plastics molded part and the second tool part includes an insert which has at least a part of the structure surface being connected to a base element;
selecting the insert from a plurality of inserts which are connectable to the base element;
placing a foil between the first tool part and the second tool part;
closing the molding tool by bringing the first tool part and the second tool part together, thereby forming a tool interior space;
injecting a plastics material into an injection space formed between the foil and the first tool part, the foil is pressed against the structure surface and the grain structure is molded as the grain onto the foil;
curing the plastics material to form the plastics molded part, and a film adheres to the plastics material while the grain is maintained; and
opening the molding tool and removing the plastics molded part from the molding tool,
wherein the shape of the structure surface corresponds to an extent surface on which the grain structure is superposed, and grain peaks and grain troughs of the grain structure are offset with respect to one another.
